(19) United States
(12) Patent Application Publication
(10) Pub. No.: US 2016/0161996 A1
(43) Pub. Date: Jun. 9, 2016

(54) ELECTRONIC DEVICE WITH BRACKET FOR DISK DRIVE

(71) Applicants: HONG FU JIN PRECISION INDUSTRY (WuHan) CO., LTD., Wuhan (CN); HON HAI PRECISION INDUSTRY CO., LTD., NewTaipei (TW)

(72) Inventors: YONG-CHANG FAN, Wuhan (CN); SAN-YONG YANG, Wuhan (CN)

(21) Appl. No.: 14/682,559

(22) Filed: Apr. 9, 2015

(30) Foreign Application Priority Data
Dec. 5, 2014 (CN) 201410731496.X

(51) Int. Cl. G06F 1/18; G06F 1/20

(52) U.S. Cl. CPC G06F 1/187; G06F 1/20

(57) ABSTRACT

Electronic device includes a host and a base supporting the host. The base includes a base body and a protecting member. A receiving portion is located on the base body, and a bracket is received in the receiving portion. The bracket is used to receive a disk drive, and the protecting member is secured to the base body and covers the bracket in the receiving portion.

### FIELD

The subject matter herein generally relates to an electronic device with a bracket for disk drive.

### BACKGROUND

An electronic device such as an all-in-one computer usually consists of a host and an integral display. Usually, there is a space in the back of the display receiving a motherboard with a plurality of electronic components, such as a CPU, a fan, and a plurality of data storage devices crammed together in the space.

### BRIEF DESCRIPTION OF THE DRAWINGS

Implementations of the present technology will now be described, by way of example only, with reference to the attached figures.

FIG. 1 is an exploded, isometric view of a first embodiment of an electronic device.

FIG. 2 is similar to FIG. 1, but viewed from a different angle.

FIG. 3 is a partial, cutaway view of a protecting member and an electromagnetic lock of the electronic device of FIG. 1.

FIG. 4 is an assembled view of the protecting member and the electromagnetic lock of FIG. 3.

FIG. 5 is an assembled view of the electronic device of FIG. 1, and a cover is located in a locked configuration.

FIG. 6 is an assembled view of the electronic device of FIG. 2.

FIG. 7 is similar to FIG. 5, but the cover is located in an unlocked configuration.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to an electronic device. The electronic device includes a host and a base supporting the host. The base includes a base body and a protecting member. A receiving portion is located on the base body, and a bracket is received in the receiving portion. The bracket is used to receive a disk drive, and the protecting member is secured to the base body and covers the bracket in the receiving portion.

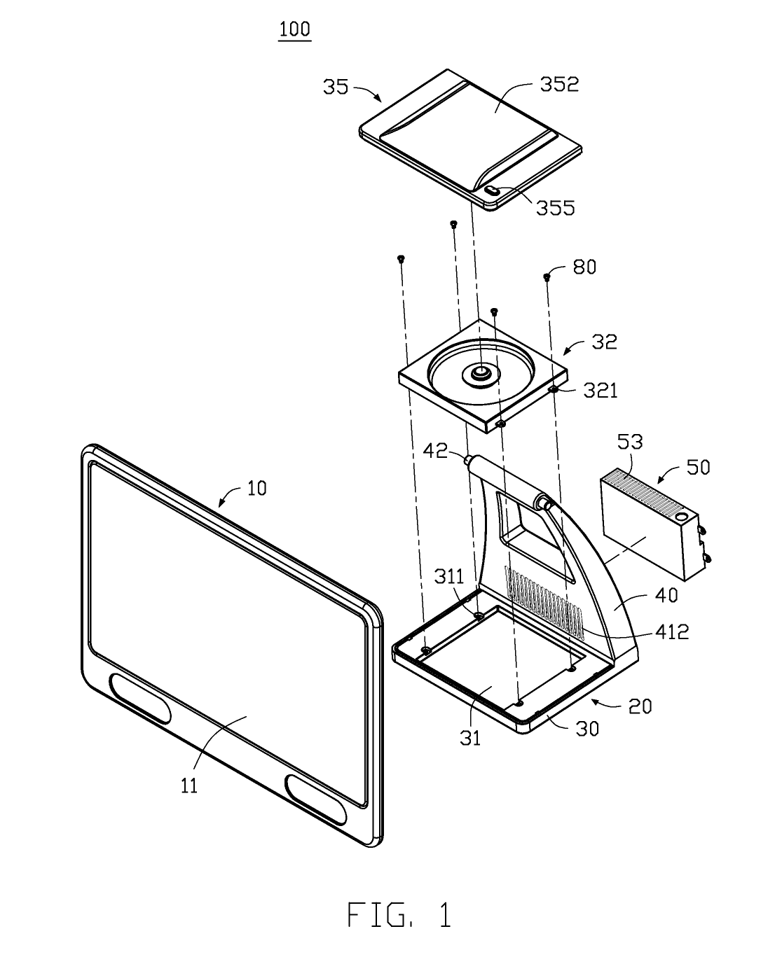

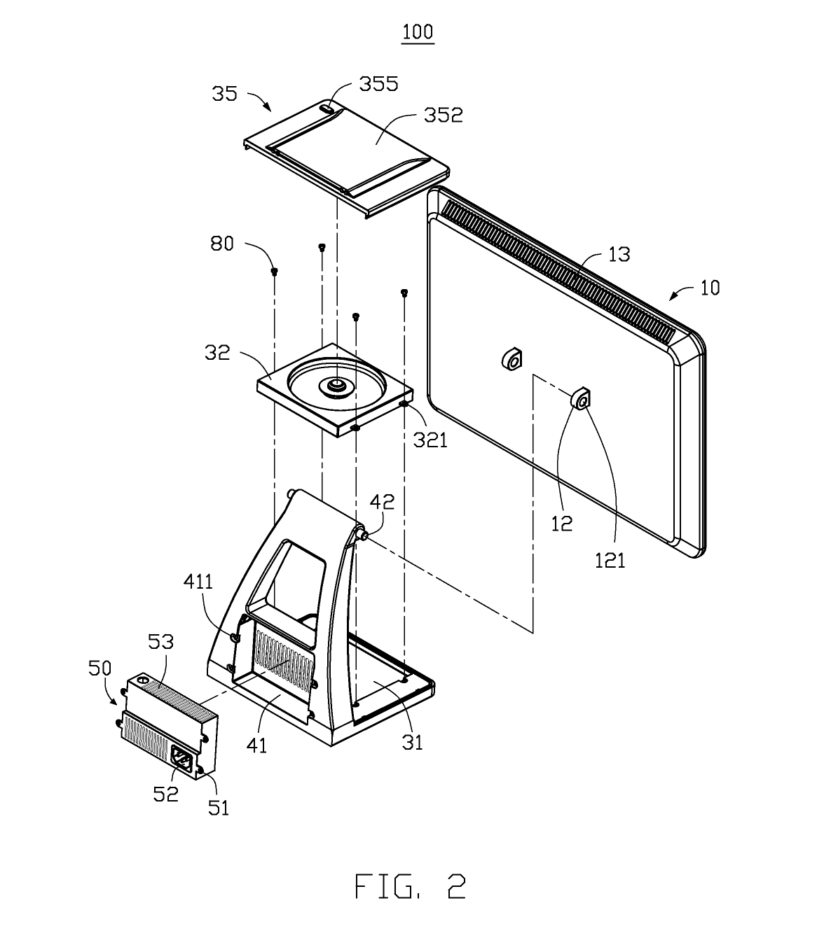

FIGS. 1 and 2 illustrate an embodiment of an electronic device 100. The electronic device 100 can include a host 10, a base 20 configured to support the host 10, and a power supply 50 secured to the base 20 supplying power for the electronic device 100.

The host 10 can include a display 11 and an enclosure 13 opposite to the display 11. A motherboard with a plurality of electronic components, such as a CPU, a fan, and a plurality of data storage devices can be positioned in the enclosure 13. Two mounting portions 12, each with a mounting hole 121, are located on the back portion of the host 10.

The base 20 can include a base body 30 and a stand 40 coupled to the base body 30. A receiving portion 31 is located on the base body 30 and is configured to secure a bracket 32 which is configured to receive an optic disk drive (not shown). Four securing holes 311, are defined in the base body 30 around the receiving portion 31. Four fixing holes 321 are defined in the bracket 32 corresponding to the four securing holes 311. Four securing members 80 can be engaged in the four fixing holes 321 and the four securing holes 311 to secure the bracket 32 to the base body 30.

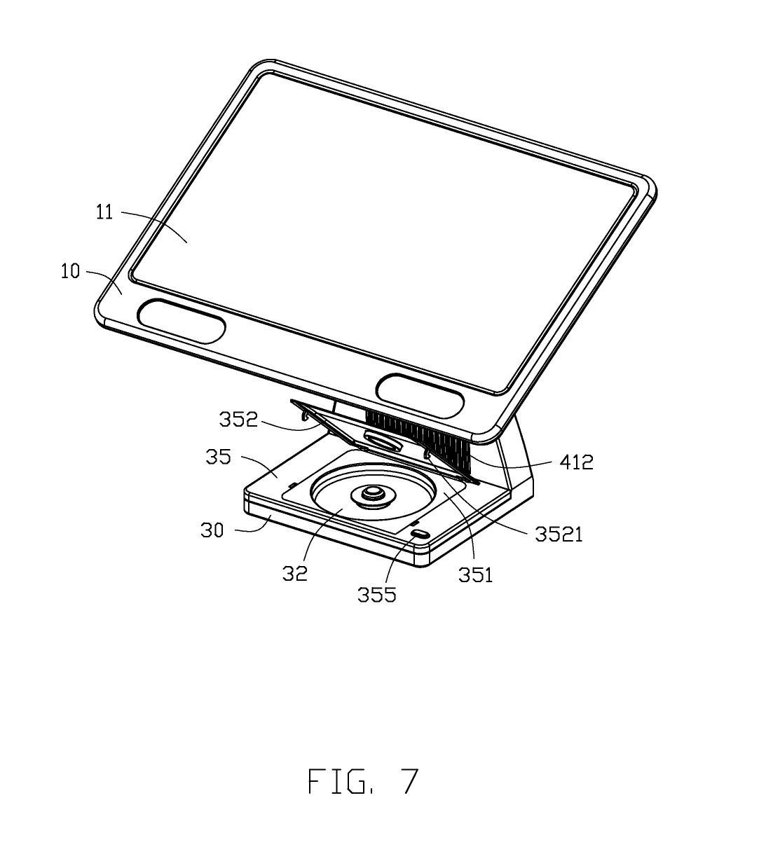

A protecting member 35 can be attached to the base body 30 for protecting the disk drive from being exposed out of the base body 30. An opening 351 (see FIG. 7) is defined in the protecting member 35 for allowing the optic disk drive to enter into the bracket 32. The protecting member 35 can include a rotatably attached cover 352 covering the opening 351.

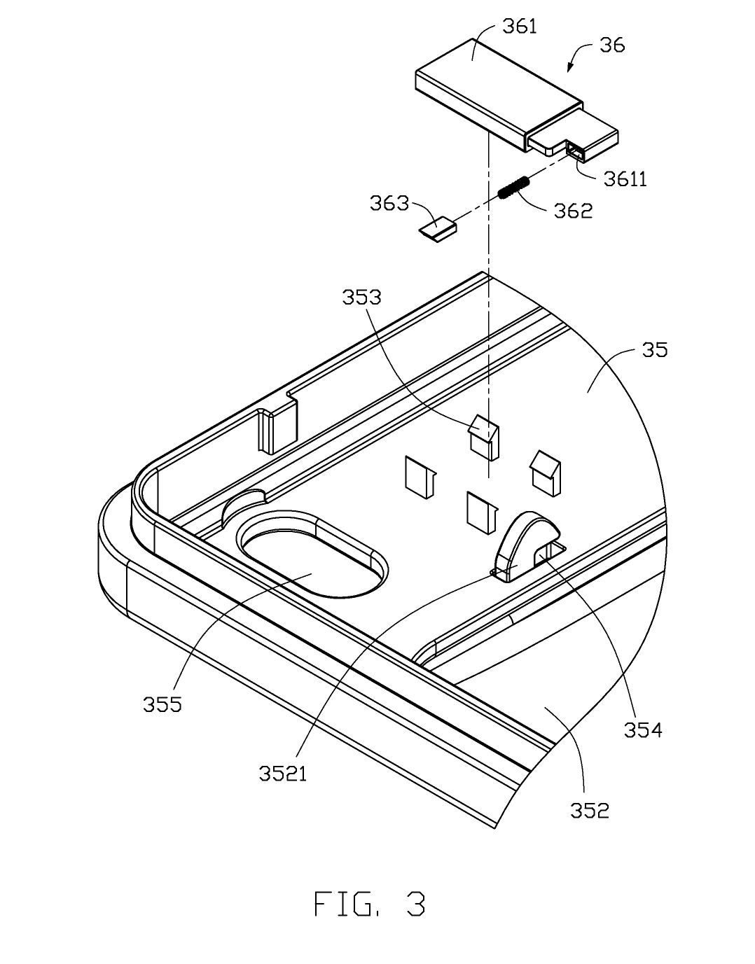

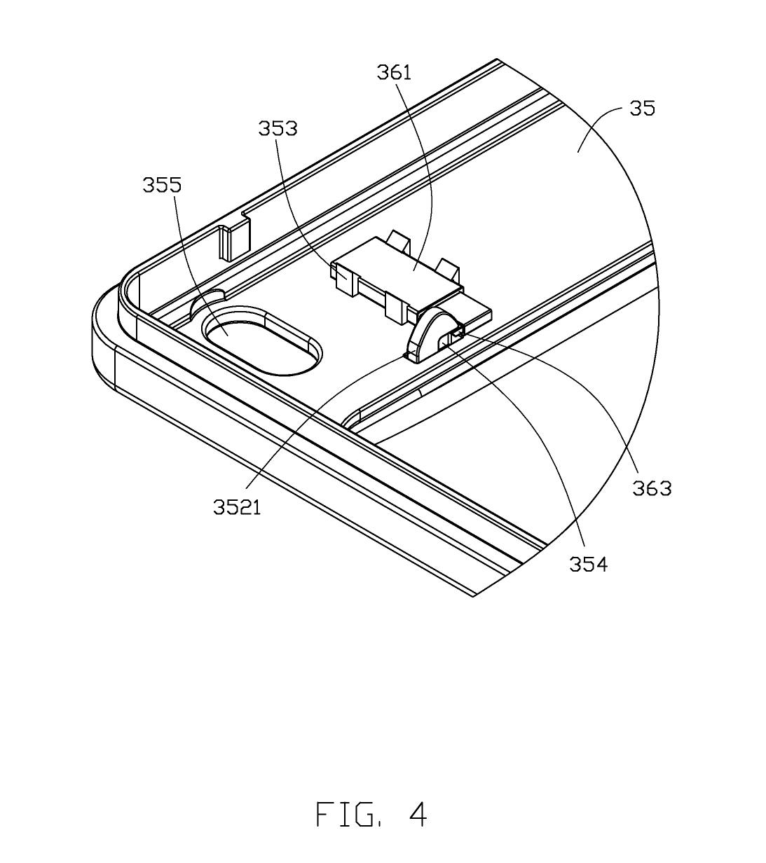

FIGS. 3 and 4 illustrate an embodiment of the protecting member 35 of the electronic device 100. The protecting member 35 can include four clipping portions 353 and a switch 355. Two through holes (see FIG. 7) are defined in the protecting member 35. An electromagnetic lock 36 can be secured to the four clipping portions 353. In at least one embodiment, the four clipping portions 353 can be located on a first side of the protecting member 35, and another four clipping portions 353 (not shown) can be located on a second opposite side of the protecting member 35 for securing another electromagnetic lock 36. The electromagnetic lock 36 can include a case 361, a spring 362, and a spring bolt 363. A receiving slot 3611 is defined in the case 361. The case 361 can be secured to the protecting member 35 by the four clipping portions 353. The spring bolt 363 can urge the spring 362 to be received in the receiving slot 3611.

Two clamping portions 3521 are located on the cover 352 and are configured to extend through the through holes 354 for clamping with the spring bolt 363. The cover 352 is rotatable relative to the protecting member 35 between a locked position (see FIG. 4) and an unlocked position (see FIG. 7). In the locked position, the two clamping portions 3521 extend through the two through holes 354 to engage with the spring bolt 363. In the unlocked position, the two clamping portions 3521 are disengaged from the spring bolt 363, and the spring 362 is deformed by the spring bolt 363. The switch 355 is electronically connected to the electromagnetic lock 36, and the switch 355 is pressed on allowing the cover 352 to be unlocked.

FIGS. 1 and 2 illustrate an embodiment of the stand 40 of the electronic device 100. An accommodating space 41 is defined in the back portion of the stand 40 and is configured for receiving the power supply 50. Four fastening holes 411 are defined in the stand 40 and are around the accommodating space 41. A plurality of heat dissipating holes 412 is defined in the front portion of the stand 40 for dissipating heat from the power supply 50. Two mounting posts 42 are located on the top portion of the stand 40 to be engaged in the two mounting holes 121.

Four retaining holes 51 are defined in the power supply 50 and correspond to the four fastening holes 411. Four securing members (not shown) can be engaged in the four retaining holes 51 and the four fastening holes 411 to secure the power supply 50 to the stand 40. A connecting port 51 is located on the power supply 50 and is configured to connect a connector (not shown). A plurality of air outlets 53 is defined in the power supply 50.

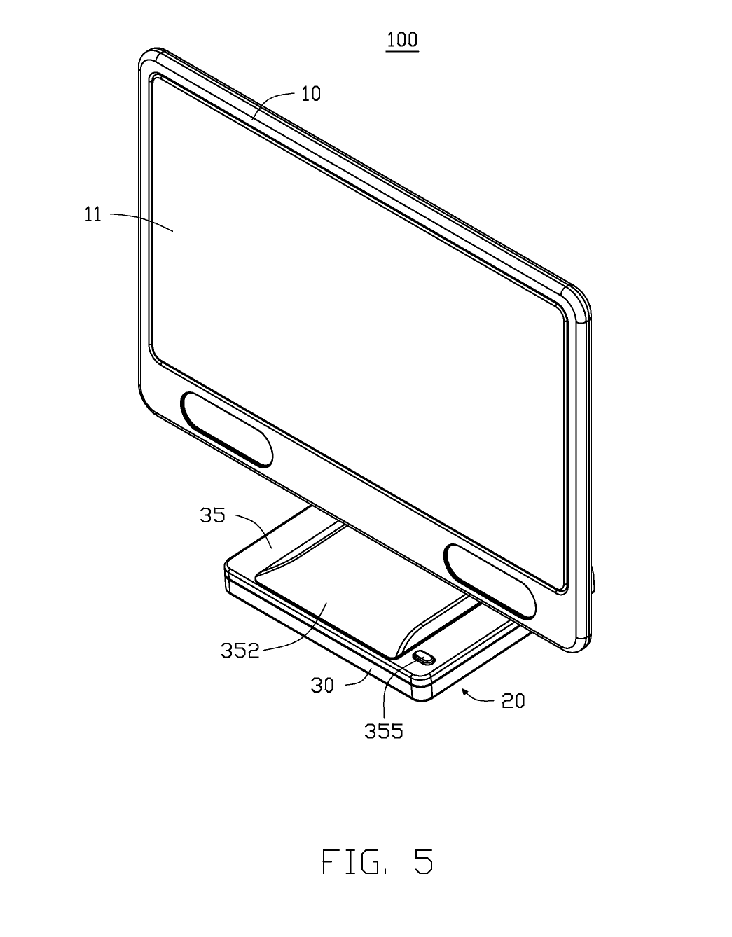

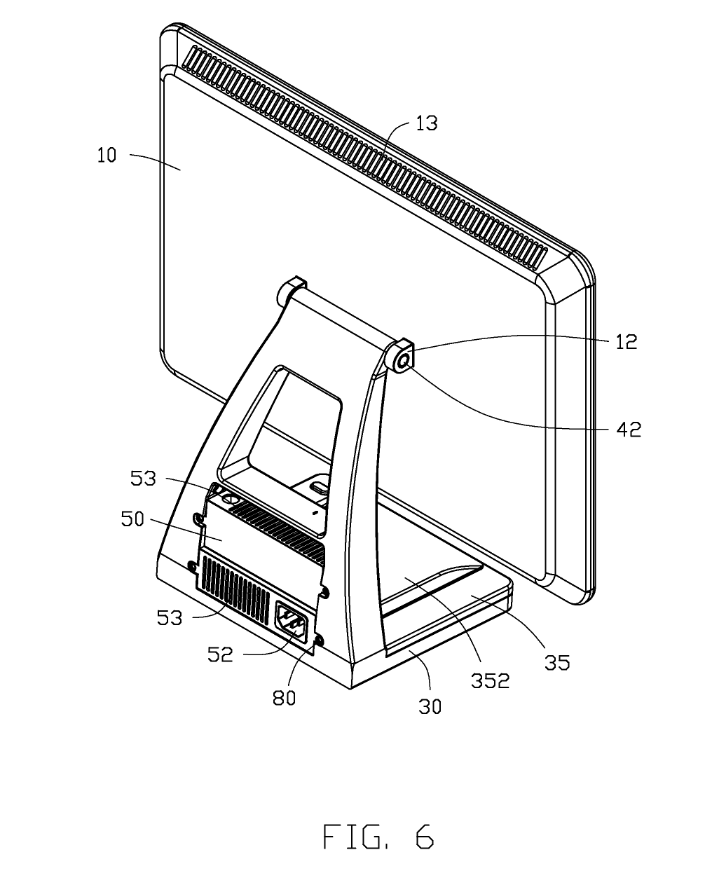

FIGS. 5 and 6 illustrate an assembled view of the electronic device 100. In assembly, the bracket 32 is received in the receiving portion 31, the four fixing holes 321 are aligned with the four securing holes 311, and the four securing members 80 are engaged in the four fixing holes 321 and the four securing holes 311 to secure the bracket 32 to the base body 30.

The spring 362 is received in the receiving slot 3611, and the spring bolt 363 is secured to one end of the spring 362. The case 361 is secured to the protecting member 35 by the four clipping portions 353. In this position, the spring bolt 363 is aligned with an end of the through hole 354. Therefore, the electromagnetic lock 36 is secured to the protecting member 35. The protecting member 35 is secured to the base body 30 by means, such as clips, and the opening 351 is aligned with the bracket 32. The cover 352 is rotated to cover the bracket 32, and the two clamping portions 3521 extend through the through holes 354 clamping with the spring bolt 363. Thus, the cover 352 is located in the locked position covering the bracket 32 preventing the optic disk drive from being exposed.

The power supply 50 is placed in the accommodating space 41, and the connecting port 52 is back to the plurality of heat dissipating holes 412. The retaining holes 51 are aligned with the fastening holes 411, and the securing members are engaged in the retaining holes 51 and the fastening holes 411 to secure the power supply 50 to the stand 40. The two mounting posts 42 are engaged in the two mounting holes 121, and the host 10 can be rotatably secured to the base 20.

FIGS. 5 and 6 illustrate that the cover 352 is open relative to the protecting member 35. When the optic disk drive needs to be located in the bracket 32, the switch 355 is pressed to switch on, and the electromagnetic lock 36 starts to deform the spring 362 in a first direction that is away from the clipping portion 3521. Thus, the spring bolt 363 can be disengaged from the clipping portion 3521 to allow the cover 352 to be located in the unlocked position, and the spring 362 is released in a second opposite direction. When the optic disk drive has been placed in the bracket 32, the cover 352 is rotated to be locked, the clamping portions 3521 extend through the through holes 354 for clamping with the spring bolt 363, thereby the cover 352 can be located on the locked position.

The embodiments shown and described above are only examples. Many details are often found in the art such as the other features of an electronic device with a bracket for disk drive. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An electronic device comprising:
a host;
a base configured to support the host, the base comprising a base body and a protecting member;
a receiving portion located on the base body; and
a bracket received in the receiving portion;
wherein the bracket is configured to receive a disk drive, and the protecting member is secured to the base body and covers the bracket.

2. The electronic device of claim 1, wherein the protecting member comprises a cover, the cover comprises a clamping portion, and an electromagnetic lock is engaged with the clamping portion.

3. The electronic device of claim 2, wherein the protecting member defines a through hole, and the clamping portion extends through the through hole to engaged with the electromagnetic lock.

4. The electronic device of claim 2, wherein a switch is located on the protecting member and is electronically connected to the electromagnetic lock, and the switch is configured to allow the electromagnetic lock to disengage from the clamping portion.

5. The electronic device of claim 2, wherein the electromagnetic lock comprises a case, and the protecting member comprises a clipping portion engaged with the case.

6. The electronic device of claim 5, wherein the case defines a receiving slot, the electromagnetic lock comprises a spring moveably received in the receiving slot and a spring bolt connected to the spring, and the clamping portion is engaged with the spring bolt.

7. The electronic device of claim 1, wherein the base further comprises a stand, and the electronic device further comprises a power supply secured to the stand.

8. The electronic device of claim 7, wherein an accommodating space is defined in the stand, and the power supply is received in the accommodating space.

9. The electronic device of claim 8, wherein the stand defines a plurality of heat dissipating holes that is face the accommodating space, and the plurality of heat dissipating holes is configured to dissipating heat from the power supply.

10. An electronic device comprising:
a host;
a base configured to support the host, and the base comprising a base body and a stand extending from the base body;
a bracket attached to the base body and configured to secure a disk drive; and
a power supply attached to the stand and configured to supply power for the electronic device.

11. The electronic device of claim 10, wherein the base further comprises a protecting member; a receiving portion is located on the base body, the bracket is received in the receiving portion, and the protecting member is secured to the base body and covers the bracket in the receiving portion.

12. The electronic device of claim 11, wherein the protecting member comprises a cover, the cover comprises a clamping portion, and an electromagnetic lock engaged with the clamping portion.

13. The electronic device of claim 12, wherein the protecting member defines a through hole, and the clamping portion extends through the through hole to engaged with the electromagnetic lock.

14. The electronic device of claim 12, wherein a switch is located on the protecting member and is electronically connected to the electromagnetic lock, and the switch is configured to allow the electromagnetic lock to disengage from the clamping portion.

15. The electronic device of claim 12, wherein the electromagnetic lock comprises a case, and the protecting member comprises a clipping portion engaged with the case.

16. The electronic device of claim 15, wherein the case defines a receiving slot, the electromagnetic lock comprises a spring moveably received in the receiving slot and a spring bolt connected to the spring, and the clamping portion is engaged with the spring bolt.

17. The electronic device of claim 10, wherein an accommodating space is defined in the stand, and the power supply is received in the accommodating space.

18. The electronic device of claim 17, wherein the stand defines a plurality of heat dissipating holes that is face the accommodating space, and the plurality of heat dissipating holes is configured to dissipating heat from the power supply.
